(19) United States
(12) Patent Application Publication
(10) Pub. No.: US 2018/0119881 A1
(43) Pub. Date: May 3, 2018

(54) METHOD FOR PREPARING THE INTERNAL SHELL OF A COMPOSITE TYPE IV RESERVOIR FOR STORING PRESSURIZED FLUID

(71) Applicant: COMMISSARIAT A L'ENERGIE ATOMIQUE ET AUX ENERGIES ALTERNATIVES, Paris (FR)

(72) Inventors: Fabien NONY, Monts (FR); Jean-Michel POIDEVIN, Monts (FR); Laurent DELNAUD, Ballan Mire (FR); Bertrand DESPREZ, Villandry (FR); Jean Remi STEPHANY, Le Havre (FR)

(73) Assignee: COMMISSARIAT A L'ENERGIE ATOMIQUE ET AUX ENERGIES ALTERNATIVES, Paris (FR)

(21) Appl. No.: 15/566,260

(22) PCT Filed: Apr. 15, 2016
(86) PCT No.: PCT/EP2016/058410

§ 371 Date: Oct. 13, 2017

(30) Foreign Application Priority Data
Apr. 15, 2015 (FR) 1553338

(51) Int. Cl. F17C 1/16; B29C 70/68; B29C 70/84; B29C 41/04; B29C 41/20

(52) U.S. Cl. CPC F17C 1/16; B29K 2077/00; B29C 70/84; B29C 41/04; B29C 41/20; F17C 2203/0604; F17C 2203/0619; F17C 2203/066; F17C 2203/0663; F17C 2203/0673; F17C 2203/0675; F17C 2205/0305; F17C 2209/2145; F17C 2209/227; F17C 2209/23; F17C 2221/012; F17C 2221/017; F17C 2221/033; F17C 2223/0123; F17C 2223/036; F17C 2270/0168; F17C 2270/0184; B29K 2023/04; B29C 70/683

(57) ABSTRACT

The present invention relates to a method for manufacturing an internal shell of a composite type IV reservoir delimiting an internal cavity intended to accommodate a pressurized fluid and comprising at least one metal baseplate allowing connection between said internal cavity and the outside of the internal shell, said baseplate or baseplates being secured to the internal shell, said method comprising the following steps:
a) a step of applying at least one adhesive layer of a first polymer to the part or parts of the metal baseplate or baseplates intended to be in direct contact with the material of which the internal shell is made;
b) a step of incorporating said baseplate or baseplates thus coated into a mould the internal cavity of which is of a shape that corresponds to the shape of the internal shell that is to be obtained;
c) a step of forming, on the internal wall of the mould and on the part or parts of the baseplate or baseplates intended to be in contact with the material of which the internal shell is made, at least one layer of a second polymer different from said first polymer and adhering to the first polymer, thus forming the aforementioned internal shell equipped with the aforementioned baseplate or baseplates.

### TECHNICAL DOMAIN

This invention relates to a method for preparing the internal shell (or internal liner) of a composite type IV reservoir for storing a pressurized fluid such as hydrogen, helium or natural gas.

Therefore, applications of this invention lie in the field of storage of fluids under pressure, such as hydrogen, particular to supply energy storage devices such as fuel cells that can be used to supply vehicles.

### STATE OF PRIOR ART

Four main types of reservoirs have been developed and can be used for the storage of fluids under pressure, and particularly for hydrogen:

“type I” reservoirs that are all-metal;

“type II” reservoirs that have a hooped metal skin on their cylindrical part, for example made of glass fibers;

“type III” reservoirs that have an outer structural skin made of composite material (glass fibers or carbon fibers or another reinforcement such as basalt, aramid fibers) and a metal internal shell or skin (also called liner) (for example made of aluminium or steel); and

“type IV” reservoirs that have an external skin made of composite material based on fibers reinforcement (for example glass fibers or carbon fibers) and an internal skin made of a polymer material or internal shell (also called liner) to perform the fluid confinement function, and particularly leak tightness. This internal shell may be fitted with one or two baseplates, usually metallic (for example made of steel or aluminium) to enable a connection to an energy conversion device, a filling device or an emptying device.

For type I and II reservoirs, and particularly reservoirs with a steel skin, steel embrittlement studies have shown limits to the life of metal reservoirs for the storage of hydrogen Furthermore, the excessive weight of this type of reservoir makes it impossible to envisage their use at high pressure for onboard applications such as use for supply to vehicles.

This disadvantage does not apply to type III and IV reservoirs that, due to the use of composite materials to form the skin, are characterised by their light weight, knowing that the mass of a reservoir made of a composite material is 25 to 75% less than the mass of a steel reservoir holding the same volume.

This lightweight characteristic also makes type IV carbon-reinforced reservoirs particularly attractive for use for the storage of hydrogen for onboard applications, although this does not prevent these reservoirs from also being used for stationary or transportable applications. Furthermore, type IV reservoirs can be less expensive, they have excellent durability of their performances, particularly regarding the number of filling/emptying cycles at high pressure compared with metal tanks in which stress cracking phenomena frequently occur. Finally, type IV reservoirs have the highest gravimetric storage density among the different families of pressurised gas reservoirs with identical reinforcing materials.

Apart from the external skin made of a composite material and the internal shell made of a polymer material, type IV reservoirs can also include one or two metal baseplates positioned at the ends of the reservoir, and said baseplates usually act as connectors to make a metallic connection to filling and/or emptying devices and energy conversion devices. The connection between the internal shell and the metal baseplate(s) forms a connection that is particularly critical for the confinement of a gas, particularly for gases with small molecules and that are therefore highly permeable, such as is the case for helium or hydrogen.

Therefore, it is found that management of this connection to achieve good performances and durability is a primordial challenge in the design of reservoirs for the storage of gas under pressure to guarantee that they will remain leaktight over their entire operating range.

Considering required targets for the costs and performance of the reservoir when cold and particularly for the material from which the internal shell is made, polyolefins and more particularly polyethylenes form ideal candidates for manufacturing of the internal shell, however they do have the characteristic that they are difficult to glue and their adhesion to metallic materials conventionally used to make the baseplates is poor (for example aluminium, steels and more specifically stainless steels), these baseplates having a smooth surface or even a mechanically treated surface (for example by grinding or sanding).

Thus, to obtain strong and durable adhesion between the baseplate and the internal shell, it is often necessary to use difficult and expensive chemical treatments such as:

treatments of baseplates by acids such as nitric acid, phosphoric acid;

phosphoric or chromic anodisation treatments when the baseplate is made of aluminium;

phosphatation treatments when the baseplate is made of steel.

Adhesion primers can then also be applied on these stripped and/or anodised surfaces to guarantee good subsequent adhesion and/or additional properties such as corrosion resistance.

In parallel to surface treatment solutions, modified polymers have been developed derived from standard polymers and more specifically from grafted polymers, in which the grafts are used particularly to create chemical bonds, for example covalent bonds with metal surfaces. However, on average these polymers are 10 times more expensive than the standard polymers from which they are derived, so that they are not very competitive for making the entire internal shell, and they have the disadvantage of being difficult to transform to their propensity to stick strongly to all surfaces (such as mould surfaces).

Therefore, considering the above, the authors set themselves the objective of disclosing a method of fabricating the internal shell of a type IV composite reservoir capable of giving a good interface between the metal baseplates and the material from which the reservoir internal shell is made, adhesion between the baseplate(s) and the internal shell having to be sufficiently strong to overcome unsticking problems under loads in service. The method must also be easy to implement and inexpensive.

### PRESENTATION OF THE INVENTION

Thus, the invention relates to a method for manufacturing an internal shell of a composite type IV reservoir delimiting an internal cavity intended to accommodate a pressurized fluid and comprising at least one metal baseplate allowing connection between said internal cavity and the outside of the internal shell, said baseplate or baseplates being secured to the internal shell, said method comprising the following steps:

a) a step of applying at least one adhesive layer of a first polymer to the part or parts of the metal baseplate or baseplates intended to be in direct contact with the material of which the internal shell is made;

b) a step of incorporating said baseplate or baseplates thus coated into a mould the internal cavity of which has a shape that corresponds to the shape of the internal shell that is to be obtained;

c) a step of forming, on the internal wall of the mould and on the part or parts of the baseplate or baseplates intended to be in contact with the material of which the internal shell is made, at least one layer of a second polymer different from said first polymer and adhering to the first polymer, thus forming the aforementioned internal shell equipped with the aforementioned baseplate or baseplates.

Before going further into the description of the invention, we will give the following definitions.

The term metal baseplate used above and in the following refers to a metal part or insert used to make the junction or connection between the internal cavity of the internal shell and the exterior of the shell, this part possibly being used for filling the internal cavity, for example with a fluid under pressure and/or draining this internal cavity. Structurally, it can be a metallic part comprising a hollow cylindrical body open at its ends, when it opens up on a surface, one if its ends being terminated by a collar that may or may not be equipped with a mechanical anchor zone such as a rim around its periphery, a cross-section of such a baseplate being shown in FIG. 1 attached in the appendix, in which references 1, 3, 5 represent the hollow cylindrical body, the collar and the rim respectively. In this configuration, the rim forms the part that will come into direct contact with the material from which the internal shell is made.

This invention is the result of a twofold choice, the choice of a first polymer capable of adhesion to the surface of the metal baseplate to perform step a) mentioned above and the choice of a second polymer capable of adhesion to the first polymer to form the internal shell for performing step b) mentioned above.

Limiting the use of a polymer capable of adhesion to the surface of the metal baseplate (such as a polymer suitably functionalised to enable adhesion to a metal surface) only to cover the baseplate and not to form the entire internal shell can limit costs because it is conventionally accepted that polymers capable of adhesion to metal surfaces are more expensive than polymers that can be used with the material from which the internal shell is made.

Furthermore, covering the part(s) of the metal baseplate that will come into contact with the shell with an adhesive polymer makes a considering contribution to improving the quality and durability or strength of the interface between this baseplate and the internal shell, since polymers are generally compatible with each other.

According to the invention, the first step in the method is to deposit an adhesive layer of a first polymer onto the part or parts of the metal baseplate or baseplates intended to be in direct contact with the material of which the internal shell is made.

Note that the term “adhesive layer of a first polymer” means a layer composed of said first polymer, that advantageously comprises groups capable of adhesion to a metal surface, in this case to the surface of the metal baseplate (for example by the formation of covalent bonds), for example adhesion possibly bring achieved through the formation of covalent bonds between said groups and said metallic surface. This implies that there is no longer any need to deposit another layer of material (for example, an adhesive layer) between the metal baseplate and the first polymer layer to make a high-performance assembly. In other words, the adhesive layer of the first polymer is directly in contact with the surface of the metal baseplate(s).

In general, this can include all groups that might generate covalent bonds with species present on the surface of the metal baseplate(s).

In particular, such groups can be chosen from among maleic anhydride groups, silane groups, silanol groups, acrylic groups, peroxide groups and combinations of these groups.

More specifically, the first polymer can be a polymer comprising a main chain comprising a first repetitive unit derived from polymerisation of an ethylenic monomer and comprising a second repetitive unit comprising a pendant chain comprising at least one group capable of adhesion to a metal surface, this group being chosen from one of the groups listed above.

Even more specifically, the first polymer can be a polymer belonging to the polyethylenes family, and more precisely a polymer comprising a repetitive ethylenic unit and a repetitive unit derived from said repetitive ethylenic unit, comprising a pendant chain comprising at least one group capable of adhesion to a metal surface, this group being chosen from one of the groups listed above.

Such a polymer can be represented by the following general formula:

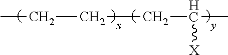

in which x and y represent numbers of repetitions of repetitive units between parentheses, the wavy link representing a pendant chain covalently bonded to the —CH-group to which one or several X groups capable of adhesion to a metal surface are bonded, such as those listed above. A single X group is shown on this formula, to simplify the representation.

As a variant, it could be a first polymer comprising a main chain comprising a first repetitive unit derived from polymerisation of an ethylenic monomer, and comprising a telechelic function at at least one of the ends of the main chain.

The above-mentioned deposition step can be performed using different deposition techniques, including non-exhaustively the manual powder sprinkling technique, the electrostatic paint deposition technique and the fluidised bed deposition technique.

The manual powder sprinkling technique classically involves the following operations:

an operation to heat the metal baseplate(s) to a temperature at least equal to the melting temperature of a powder of the first polymer;

an operation to bring the baseplate(s) thus heated into contact with a powder of said first polymer, as a result of which the powder bonds to the surface of the metal baseplate(s) thus forming a coat covering said metal baseplate(s), this operation to create contact possibly being repeated one or several times until a layer of the required thickness is obtained.

If required, the baseplate(s) can be held at a temperature at least equal to the above-mentioned melting temperature, placing said baseplate(s) in an oven heated to a, appropriate temperature between two operations creating contact.

With the electrostatic paint deposition technique, the electrostatic paint is applied by dispersion of the first polymer powder, this paint possibly being applied by spraying of one or several coats of paint on the baseplate(s). With two coats of paint, if applicable and/or at the end of the paint deposition step, the baseplate(s) can be held at a temperature equal to at least the melting temperature mentioned above (in other words, the melting temperature of the powder contained in the dispersion), by placing said baseplate(s) in an oven heated to the appropriate temperature.

Finally, with the fluidised bed deposition technique, the metal baseplate(s), generally previously heated to a temperature equal to at least the melting temperature of a powder of the first polymer, is (are) conventionally introduced into a receptacle containing said powder moved by a gas flow introduced at the bottom of the receptacle. Powder particles coming into contact with the surface of the metal baseplate(s) melt, as a result of which they adhere to this surface forming a layer with increasing thickness.

Before the step in which step a) is implemented, the method according to the invention can include a step in which the part(s) of the baseplate are masked so that they are not coated by a layer of the first polymer (this or this parts subsequently forming the part(s) of the baseplate that will not be in direct contact with the material from which the internal shell is made). More specifically, this masking step can consist of covering said above-mentioned part(s), for example with an insulating plastic part such as a heat-resistant adhesive tape (for example up to a temperature of 200° C., as can be the case for teflon or a polyimide) or by any other means, that would prevent deposition of a layer of the first polymer in unwanted zones (in particular, zones that will come into direct contact with the walls of the mould). When the baseplate comprises one or several openings, for example in the form of a reaming or a thread, this or these openings can be blocked off by a plug, for example made of teflon, before step a) is implemented.

Before implementation of step a), and the possible masking and closing off steps, a cleaning or degreasing step can advantageously be performed on the metal baseplate(s), for example using an organic solvent such as acetone.

As a variant, it might be possible to envisage anodising the surface of the metal baseplate, particularly when it is made of aluminium, such that the oxide(s) present on the surface are cohesive or to create a special surface structure to further improve the assembly.

Before the step to implement step a), the method includes a step b) in which said baseplate(s) thus coated is (are) introduced into a mould in which the shape of the internal cavity corresponds to the shape of the internal shell to be obtained, this step b) being followed directly by a step c) to deposit at least one layer of a second polymer different from said first polymer and adhering to said first polymer, on the internal wall of the mould and on the part(s) of the baseplate(s) that will come into contact with the material of the internal shell, thus forming the above-mentioned shell fixed to the metal baseplate(s).

When the geometry of the metal baseplate is similar to the geometry illustrated in FIG. 1, it can be introduced into the mould such that the collar is in direct contact with the wall of the mould, and such that the hollow cylindrical body passes through an opening in the mould with a diameter such that the cylindrical body can be introduced through this opening. FIG. 2 illustrates the part of a mould showing the baseplate thus introduced, references 1, 3, 5 and 7 illustrating the hollow cylindrical body of the baseplate, the collar, the rim and the wall of the mould in direct contact with the collar, respectively.

The shell can be formed by conventional moulding methods, and preferably by rotational moulding.

Rotational moulding conventionally includes the following operations:

i) after the baseplate(s) treated according to step a) of the method have been put into the mould, an operation to fill the internal cavity of the mould with a second polymer powder;

ii) an operation to heat the mould to a temperature at least equal to the melting temperature of the second polymer;

iii) concomitantly with step ii), an operation to rotate the mould, thus generating a deposit on the internal wall of the mould and on the parts of the baseplate(s) emerging into the internal cavity of the mould, as a result of which a shell is obtained with a shape corresponding to the internal geometry of the mould;

iv) possibly, a step in which steps i) to iii) are reiterated in order to make several layers of the second polymer, in order to obtain a larger thickness;

ivi) possibly, one or several steps in which steps i) to iii) are reiterated but with a powder of another polymer different from the second polymer so as to combine the properties of the second polymer and the other polymer (for example to form a three-layer structure);

ivii) a cooling operation to solidify the deposit(s).

In particular, the mould rotation operation can advantageously be made around two generally perpendicular rotation axes, in order to provoke a uniform deposit of the second polymer on the internal wall of the mould and on the part(s) of the baseplate(s) emerging into the internal cavity of the mould.

This second polymer must be capable of adhering to the first polymer.

Note that an adhesive layer of a second polymer means a layer composed of said second polymer that includes groups capable of adhering to the surface of the coat of the first polymer, for example by interdiffusion of polymer chains at the interface. This means that another layer (for example an adhesive layer) is not inserted between the first polymer layer and the second polymer layer to achieve adhesion. In other words, the second polymer layer is directly in contact with the surface of the first polymer layer.

The second polymer can be a thermoplastic polymer and more specifically a polymer belonging to the polyethylenes family, in other words including an ethylene repetitive unit, but this does not mean that they cannot contain other repetitive units. For example, they could be standard polyethylenes, in other words linear or ramified polyethylenes, for example that only include a single repetitive ethylene unit.

The second polymer can also be a polymer belonging to the polyamides family, such as a polyamide-12 or a polyamide-11.

Preferably, this second polymer is advantageously a polymer including a part of its repetitive units identical to those of the first polymer.

For example, when the first polymer belongs to the polyethylenes family, and more specifically a polymer comprising a repetitive ethylene unit and a repetitive unit derived from said repetitive ethylene unit comprising a pendant chain including at least one group capable of adhering to a metal surface, the second polymer can be a polymer comprising a single repetitive unit, that is an ethylene unit (in which case the second polymer is a polyethylene). Consequently, the second polymer adheres perfectly to the first polymer layer deposited on the baseplate(s) by a polymer chain self-adhesion or interdiffusion mechanism, taking account particularly of the temperatures involved. This self-adhesion or interdiffusion mechanism can also occur when the first polymer and the second polymer do not contain identical repetitive units, provided that they are compatible.

Once step c) has been completed, the method according to the invention conventionally includes a step to strip the internal shell from the walls of the mould possibly using a mould stripping agent that had previously been applied to the inside surface of the mould (in other words before the step to form the internal shell). For example, the mould stripping agent can be a product in the aqueous phase deposited with a brush and then polished and baked in the mould, thus forming a layer on the internal surface of the mould. It can consist of commercial products supplied by Chem-trend® such as products in the Chemlease® range, or products supplied by Loctite® such as products in the Frekote® range or products supplied by Elgadi Chemicals such as products in the Elkoat® range. These mould stripping agents can be qualified as semi-permanent mould stripping agents because they have to be replaced after a certain number of inner shells have been made (for example, a number of shells equal to between 10 and more than 100).

The mould stripping agent can also consist of a permanent mould stripping agent, such an agent possibly consisting of a layer deposited on the internal surface of the mould made from a material chosen from among teflon, nickel, ballinite®, this layer being stable for the manufacture of at least 1000 shells.

One the internal shell with its baseplate(s) has been obtained, to obtain a type IV reservoir the previously obtained internal shell has to be surrounded by a composite material with fibrous reinforcement to reinforce the internal shell, to guarantee mechanical resistance of the reservoir under pressure.

The invention also relates to a method of preparing a composite type IV reservoir including the following steps:

a step to implement the method for preparing an internal shell of a type IV composite reservoir like that defined above; and

a step to deposit a fibrous material on the external surface of the shell thus obtained in the previous step, to form the external skin of the reservoir.

The deposition step can be performed particularly by filament winding of continuous fibers impregnated with a resin on the external surface of the internal shell, to form the composite material with fibrous reinforcement.

Other characteristics and advantages of the invention will become clear after reading the remaining description given below.

However, it should be understood that the remaining description is only given to illustrate the purpose of the invention and in no way forms a limitation of this purpose.

### BRIEF DESCRIPTION OF THE FIGURES

FIG. 1 shows a cross-sectional view of a baseplate that can be used for implementation of the method according to the invention.

FIG. 2 shows a cross-sectional view of a baseplate like that illustrated in FIG. 1 positioned in a mould that can be used for implementation of the method according to the invention.

### DETAILED PRESENTATION OF PARTICULAR EMBODIMENTS

### EXAMPLE 1

This example illustrates the preparation of an internal shell of a pressurised fluid storage reservoir comprising an aluminium baseplate.

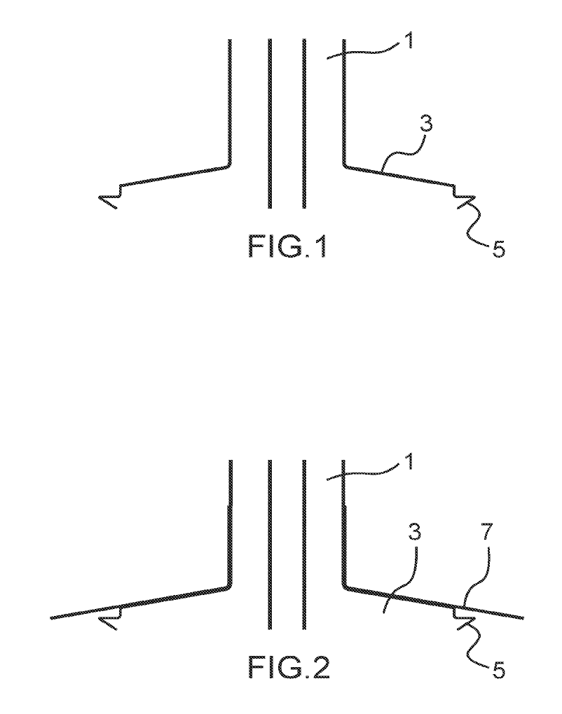

To achieve this, the first step is to cover the part of the baseplate that will be directly in contact with the shell material by manually sprinkling a powder of a grafted polyethylene of the Matrix N211 type (namely a polyethylene in which the grafts comprise maleic anhydride groups). This baseplate resembles that illustrated in the appended FIG. 1.

More specifically, for this step, the metal baseplate is preheated to a temperature of 160° C. followed by 2 successive passes of the baseplate in a receptacle comprising a powder of the above-mentioned grafted polyethylene, each of these passes being separated by the baseplate being passed into an oven for 3 minutes at 160° C. The baseplate is thus covered by an approximately 0.8 mm thick layer.

Secondly, the baseplate thus coated is place in a rotational mould, the internal cavity of which is filled with standard polyethylene (in other words polyethylene that only includes the single repetitive ethylene unit) of the Matrix 6402 U type. The mould is then rotated about two orthogonal axes and its temperature is increased to 210° C. (maximum recorded air temperature inside the mould during the fabrication cycle), as a result of which a polyethylene shell fixed to the baseplate is obtained, allowing communication between the internal cavity of the shell and the exterior. The assembly formed by the shell and the baseplate has excellent resistance, in other words there are no decohesion phenomena between the surface of the baseplate and the grafted polyethylene and between the grafted polyethylene and the standard polyethylene.

Torsion torques exceeding 100 Nm can be applied to this baseplate/internal shell assembly without damaging the connection. Nor is this assembly damaged by a cross-cut through this assembly. Furthermore, no decohesion is observed when pressure cycles are applied to a reservoir including this assembly.

### EXAMPLE 2

This example illustrates the preparation of an internal shell of a pressurised fluid storage reservoir comprising an aluminium baseplate.

To achieve this, the first step is to cover the part of the baseplate that will be directly in contact with the shell material by manually sprinkling a powder of a grafted polyethylene of the Matrix N211 type (namely a polyethylene in which the grafts comprise maleic anhydride groups).

More specifically, for this step, the metal baseplate is preheated to a temperature of 160° C. followed by 2 successive passes of the baseplate in a receptacle comprising a powder of the above-mentioned grafted polyethylene, each of these passes being separated by the baseplate being passed into an oven for 3 minutes at 160° C. The baseplate is thus covered by an approximately 0.8 mm thick layer.

Secondly, the baseplate thus coated is placed in a rotational mould, the internal cavity of which is filled with a Matrix XL400 type cross-linkable polyethylene (namely a polyethylene comprising a peroxide type cross-linking agent that initiates the cross-linking reaction at a temperature equal to approximatively 150° C.). The mould is then rotated, as a result of which a cross-linked polyethylene shell is obtained fixed to the baseplate that enables communication between the internal cavity of the shell and the outside. The assembly formed by the shell and the baseplate has excellent resistance, in other words there are no decohesion phenomena between the surface of the baseplate and the grafted polyethylene and between the grafted polyethylene and the cross-linked polyethylene.

### EXAMPLE 3

This example illustrates the preparation of an internal shell of a pressurised fluid storage reservoir comprising an aluminium baseplate.

To achieve this, the first step is to cover the part of the baseplate that will be directly in contact with the shell material by manually sprinkling a powder of a grafted polyolefin of the XP 9015 type comprising specific grafts that can increase adhesion and is compatible with polyamides, such as a polyamide-12.

More specifically, for this step, the metal baseplate is preheated to a temperature of 160° C. followed by 2 successive passes of the baseplate in a receptacle comprising a powder of the above-mentioned grafted polyolefin, each of these passes being separated by the baseplate being passed into an oven for 3 minutes at 160° C. The baseplate is thus covered by an approximately 0.8 mm thick layer.

The baseplate thus coated is then placed in a rotational mould, the internal cavity of which is filled with a quantity of micronised polyamide-12 powder, for example of the Rilsan® or Matrix ARVO950 type adapted to the required thickness. The mould is then rotated and heated to a maximum temperature of 210° C., and is then cooled, as a result of which a polyamide-12 shell is obtained fixed to the baseplate that enables communication between the internal cavity of the shell and the outside. The assembly formed by the shell and the baseplate has excellent resistance, in other words there are no decohesion phenomena between the surface of the baseplate and the XP9015 grafted polymer and between the XP9015 grafted polymer and the polyamide-12.

### EXAMPLE 4

This example illustrates the preparation of an internal shell of a pressurised fluid storage reservoir comprising an aluminium baseplate.

To achieve this, the first step is to cover the part of the baseplate that will be directly in contact with the shell material by manually sprinkling a powder of a grafted metallocene polyethylene of the Lumicene mPE3671 type.

More specifically, for this step, the metal baseplate is preheated to a temperature of 160° C. followed by 2 successive passes of the baseplate in a receptacle comprising a powder of the above-mentioned grafted polyethylene, each of these passes being separated by the baseplate being passed into an oven for 3 minutes at 160° C. The baseplate is thus covered by an approximately 0.8 mm thick layer.

The baseplate thus coated is then placed in a rotational mould, part of the internal cavity of which is filled with a polyamide-11 and is heated to 220° C. The mould is then rotated, as a result of which a polyamide-11 shell fixed to the baseplate is obtained, that enables communication between the internal cavity of the shell and the outside. The assembly formed by the shell and the baseplate has excellent resistance, in other words there are no decohesion phenomena between the surface of the baseplate and the grafted polyethylene and between the grafted polyethylene and the polyamide-11.

### COMPARATIVE EXAMPLE 1

This example illustrates the preparation of an internal shell of a pressurised fluid storage reservoir comprising an aluminium baseplate.

To achieve this, the first step is to degrease the aluminium baseplate, that is not coated with an adhesive polymer, as is the case in the method according to the invention.

Secondly, the baseplate is placed in a rotational mould, the internal cavity of which is filled with standard polyethylene (in other words a polyethylene that only includes a single repetitive ethylene unit) of the Matrix 6402 U type. The mould is then rotated about two orthogonal axes and its temperature is increased to 210° C. (maximum recorded air temperature inside the mould during the fabrication cycle), as a result of which a polyethylene shell fixed to the baseplate is obtained, allowing communication between the internal cavity of the shell and the exterior.

After cooling, decohesion of the metal baseplate with the polymer forming the shell induced by thermal shrinkage of the polymer is observed over an approximately 800 nm length.

The visual analysis confirms that the two surfaces are completely smooth and that there is no adhesion.

1. Method for manufacturing an internal shell of a composite type IV reservoir delimiting an internal cavity intended to accommodate a pressurized fluid and comprising at least one metal baseplate allowing connection between said internal cavity and the outside of the internal shell, said baseplate or baseplates being secured to the internal shell, said method comprising the following steps:
a) a step of applying at least one adhesive layer of a first polymer to the part or parts of the metal baseplate or baseplates intended to be in direct contact with the material of which the internal shell is made;
b) a step of incorporating said baseplate or baseplates thus coated into a mould the internal cavity of which has a shape that corresponds to the shape of the internal shell that is to be obtained;
c) a step of forming, on the internal wall of the mould and on the part or parts of the baseplate or baseplates intended to be in contact with the material of which the internal shell is made, at least one layer of a second polymer different from said first polymer and adhering to the first polymer, thus forming the aforementioned internal shell equipped with the aforementioned baseplate or baseplates.

2. Method according to claim 1, in which the first polymer comprises groups capable of adhering to a metal surface by the formation of covalent bonds.

3. Method according to claim 2, in which said groups are chosen from among maleic anhydride groups, silane groups, silanol groups, acrylic groups, peroxide groups and combinations of these groups.

4. Method according to claim 3, in which the first polymer is a polymer comprising a main chain comprising a first repetitive unit derived from polymerisation of an ethylenic monomer and comprising a second repetitive unit comprising a pendant chain comprising at least one group capable of adhesion to a metal surface as defined in claim 3.

5. Method according to claim 1, in which the first polymer is a polymer belonging to the polyethylenes family.

6. Method according to claim 3, in which the first polymer is a polymer comprising a repetitive ethylenic unit and a repetitive unit derived from said repetitive ethylenic unit, comprising a pendant chain comprising at least one group capable of adhesion to a metal surface, this group being chosen from among the groups listed in claim 3.

7. Method according to claim 1, in which the deposition steps a) is done using the manual powder sprinkling technique, the electrostatic paint deposition technique or the fluidised bed deposition technique.

8. Method according to claim 1, in which step c) is done by rotational moulding.

9. Method according to claim 1, in which the second polymer is a thermoplastic polymer.

10. Method according to claim 1, in which the second polymer is a polymer in which some of its repetitive units are identical to those of the first polymer.

11. Method according to claim 1, in which the second polymer is a polymer belonging to the polyethylenes family or the polyamides family.

12. Method according to claim 11, in which, when the second polymer is a polymer belonging to the polyethylenes family, it is a linear or ramified polyethylene.

13. Method according to claim 11, in which, when the second polymer is a polymer belonging to the polyamides family, it is a polyamide-11 or a polyamide-12.

14. Method of preparing a composite type IV reservoir including the following steps:
a step to implement the method for preparation of an internal shell of a type IV composite reservoir like that defined in claim 1; and
a step to deposit a fibrous material on the external surface of the shell thus obtained in the previous step, to form the external skin of the reservoir.
